(19) United States
(12) Patent Application Publication
(10) Pub. No.: US 2014/0292258 A1
(43) Pub. Date: Oct. 2, 2014

(54) ELECTRONIC DEVICE AND CHARGING CIRCUIT THEREOF

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: HAI-QING ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/226,298

(22) Filed: Mar. 26, 2014

(30) Foreign Application Priority Data
Mar. 28, 2013 (CN) 2013101038891

(51) Int. Cl. H02J 7/00

(52) U.S. Cl. CPC H02J 7/0052
USPC 320/107

(57) ABSTRACT

A charging circuit is used to charge a rechargeable battery. The charging circuit includes a voltage conversion unit and a diode. The voltage conversion unit is electrically connected to an anode of the diode. A cathode of the diode is electrically connected to a positive terminal of the rechargeable battery. A negative terminal of the rechargeable battery is grounded. The voltage conversion unit is used to convert a voltage of a power supply into an operation voltage, and output the operation voltage to the diode. When the voltage conversion unit outputs the operation voltage, the diode is turned on. The operation voltage is reduced by the diode into a charging voltage of the rechargeable battery, and the rechargeable battery is charged by the charging voltage. When the voltage conversion unit does not output the charging voltage, the diode is turned off to prevent leakage of the rechargeable battery.

### FIELD

The present disclosure relates to electronic devices, and particularly to an electronic device with a charging circuit.

### BACKGROUND

Generally, rechargeable batteries need a dedicated charger to be charged. However, if the dedicated charger is not on hand, there is no way to charge the rechargeable batteries.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is an isometric view of an example embodiment of an electronic device comprising a charging circuit.

FIG. 2 is an example circuit diagram of the charging circuit of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references can mean “at least one.”

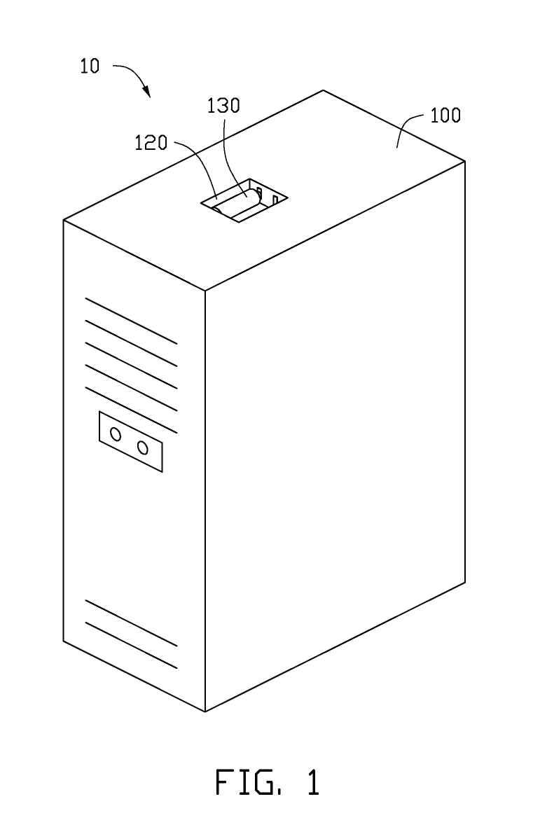

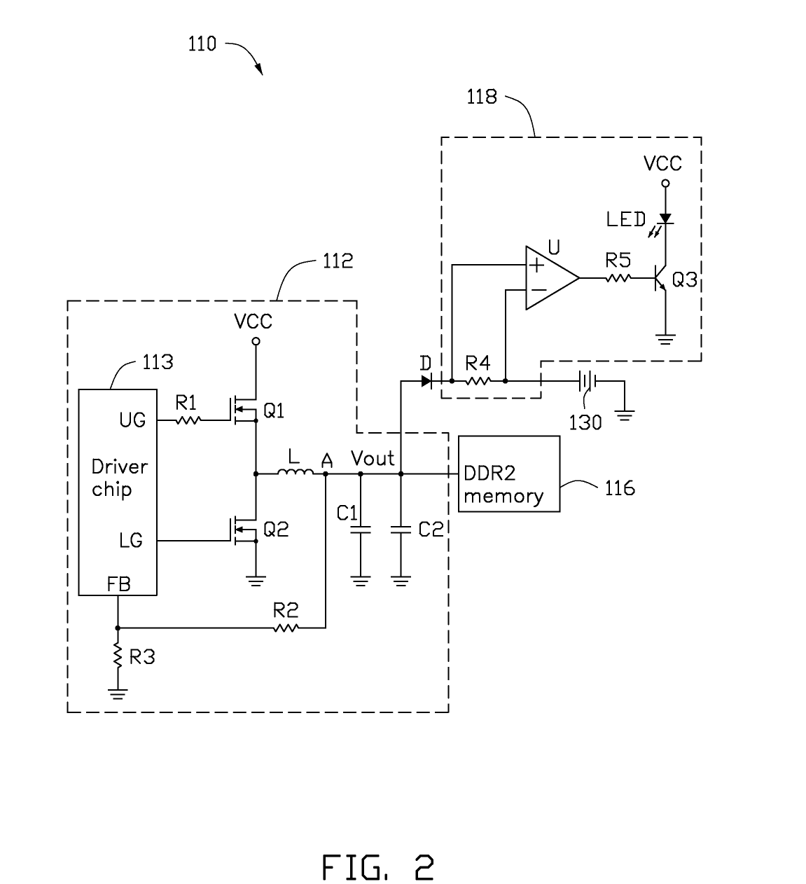

FIGS. 1 and 2 show an embodiment of an electronic device 10. The electronic device 10 can comprise a shell 100 and a charging circuit 110 received in the shell 100. The shell 100 can have a recess 120 formed therein to receive a rechargeable battery 130. The rechargeable battery 130 can be electrically connected to the charging circuit 110. In one embodiment, the electronic device 10 can include a chassis of a desktop computer.

The charging circuit 110 comprises a voltage conversion unit 112, a diode D, and a display unit 118. The voltage conversion unit 112 can be electrically connected to an anode of the diode D. A cathode of the diode D can be electrically connected to a positive terminal of the rechargeable battery 130 through the display unit 118. A negative terminal of the rechargeable battery 130 can be electrically connected to a ground. The voltage conversion unit 112 can be used for converting a voltage of a power supply VCC of a motherboard into an operation voltage Vout, and outputting the operation voltage Vout to the diode D. When the voltage conversion unit 112 outputs the operation voltage Vout, the diode D is turned on. The operation voltage Vout can be reduced by the diode D into a charging voltage of the rechargeable battery 130, and the rechargeable battery 130 can be charged by the charging voltage. When the voltage conversion unit 112 does not output the operation voltage Vout, the diode D is turned off to prevent leakage of the rechargeable battery 130. The display unit 118 can be used for displaying whether the rechargeable battery 130 is being charged or not.

The voltage conversion unit 112 can comprise a driver chip 113, a first electronic switch Q1, a second electronic switch Q2, an inductor L, a first capacitor C1, a second capacitor C2, and first through third resistors R1-R3. The driver chip 113 can comprise a first control pin UG, a second control pin LG, and a feedback pin FB. Each of the first electronic switch Q1 and the second electronic switch Q2 can comprise a first terminal, a second terminal, and a third terminal The first terminal of the first electronic switch Q1 can be electrically connected to the first control pin UG of the driver chip 113 through the first resistor R1. The second terminal of the first electronic switch Q1 can be electrically connected to the power supply VCC. The third terminal of the first electronic switch Q1 can be electrically connected to a ground through the inductor L and the first capacitor C1 in that order. The first terminal of the second electronic switch Q2 can be electrically connected to the second control pin LG of the driver chip 113. The second terminal of the second electronic switch Q2 can be electrically connected to the third terminal of the first electronic switch Q1. The third terminal of the second electronic switch Q2 can be grounded. Node A between the inductor L and the first capacitor C1 can function as an output terminal of the voltage conversion unit 112. Node A can be electrically connected to the anode of the diode D to output the operating voltage Vout to the diode D. The output terminal of the voltage conversion unit 112 can be electrically connected to a ground through the second capacitor C2. The feedback pin FB of the driver chip 113 can be electrically connected to the output terminal of the voltage conversion unit 112 through the second resistor R2, and electrically connected to a ground through the third resistor R3.

Display unit 118 can comprise a comparator U, a light-emitting diode LED, a third electronic switch Q3, a fourth resistor R4, and a fifth resistor R5. Comparator U can comprise a non-inverting terminal, an inverting terminal, and an output terminal The third electronic switch Q3 can comprise a first terminal, a second terminal, and a third terminal The non-inverting terminal of the comparator U can be electrically connected to the cathode of the diode D. The inverting terminal of the comparator U can be electrically connected to a positive terminal of the rechargeable battery 130, and can be further electrically connected to the non-inverting terminal of the comparator U through the fourth resistor R4. A negative terminal of the rechargeable battery 130 can be electrically connected to a ground. The first terminal of the third electronic switch Q3 can be electrically connected to the output terminal of the comparator U through the fifth resistor R5. The second terminal of the third electronic switch Q3 can be electrically connected to the cathode of the light-emitting diode LED. The third terminal of the third electronic switch Q3 can be grounded. An anode of the light-emitting diode LED can be electrically connected to the power supply VCC.

When the rechargeable battery 130 needs to be charged, the rechargeable battery 130 can be received in shell 100 having a recess 120 formed therein and electrically connected to the charging circuit 110.

In use, the first control pin UG and the second control pin LG of the driver chip 113 can alternately output high-level signals to alternately turn on the first electronic switch Q1 and the second electronic switch Q2. In an example embodiment, when the first control pin UG outputs a high-level signal, such as logic 1, and the second control pin LG outputs a low-level signal, such as logic 0, the first electronic switch Q1 is turned on, and the second electronic switch Q2 is turned off Thus, the inductor L and the first capacitor C1 can be charged by the power supply VCC through the first electronic switch Q1. In another example embodiment, when the first control pin UG outputs a low-level signal while the second control pin LG outputs a high-level signal, the first electronic switch Q1 is turned off, and the second electronic switch Q2 is turned on. Thus, the inductor L and the first capacitor C1 are discharged through the second electronic switch Q2, and the output terminal of the voltage conversion unit 112 can then output the operation voltage Vout.

In an example embodiment, when the output terminal of the voltage conversion unit 112 outputs the operation voltage Vout, the diode D can be turned on, the operation voltage Vout can be reduced to the charging voltage by the diode D, and the rechargeable battery 130 can be charged by the charging voltage. When the rechargeable battery 130 is charged by the charging voltage, a voltage at the non-inverting terminal of the comparator U can be greater than a voltage at the inverting terminal of the comparator U, which can result in the output terminal of the comparator U outputting a high-level signal, such as logic 1. The high-level signal output by the output terminal of the comparator U can cause the third electronic switch Q3 to turn on. When the third electronic switch Q3 is turned on, the light-emitting diode LED can light up to indicate the rechargeable battery 130 is being charged.

In an example embodiment, when the output terminal of the voltage conversion unit 112 does not output the operation voltage Vout, the diode D can be turned off to prevent leakage of the rechargeable battery 130, and the voltage at the non-inverting terminal of the comparator U can be substantially equal to the voltage at the inverting terminal of the comparator U. When the voltages at the inverting terminal and non-inverting terminal of the comparator U are substantially equal, the output terminal of the comparator U outputs a low-level signal, such as logic 0, which can cause the third electronic switch Q3 to turn off When the third electronic switch Q3 turns off, the light-emitting diode LED is not lit up to indicate that the rechargeable battery 130 is not being charged.

In an example embodiment, when the rechargeable battery 130 is fully charged, the voltage at the non-inverting terminal of the comparator U can be substantially equal to the voltage at the inverting terminal of the comparator U, so the output terminal of the comparator U outputs the low-level signal. Thus, the third electronic switch Q3 is turned off, and the light-emitting diode LED is not lit up.

In an example embodiment, the output terminal of the voltage conversion unit 112 can be further electrically connected to an electronic element, such as a double data rate 2 (DDR2) memory 116 of the electronic device 10, to supply power to the DDR2 memory 116. The operation voltage Vout can be an operation voltage of the DDR2 memory 116. The operation voltage Vout can be about 1.8 volts (V), and the charging voltage can be about 1.5V. The diode D can be a Schottky diode. Each of the first electronic switch Q1 and the second electronic switch Q2 can be an n-channel metal-oxide semiconductor field-effect transistor (NMOSFET), and the first terminal, the second terminal, and the third terminal of the first electronic switch Q1 and the second electronic switch Q2 can be a gate, a drain, and a source of the NMOSFET, respectively. The third electronic switch Q3 can be an npn-type bipolar junction transistor (BJT), and the first terminal, the second terminal, and the third terminal of the third electronic switch Q3 can be a base, a collector, and an emitter of the npn-type BJT, respectively. In other example embodiments, the output terminal of the voltage conversion unit 112 can be electrically connected to other electronic elements of the electronic device 10 to supply power to the electronic elements, and the operation voltage Vout can be an operation voltage of the other electronic elements. Both a voltage of the operation voltage Vout and of the charging voltage can be adjusted according to actual need. Each of the first electronic switch Q1 and the second electronic switch Q2 can be an npn-type BJT or other switch having similar functions. The third electronic switch Q3 can be an NMOSFET or other switch having similar functions.

As detailed above, by employing the voltage conversion unit 112 to convert the power supply VCC into the operation voltage Vout, employing the diode D to reduce the operation voltage Vout into the charging voltage to charge the rechargeable battery 130, and employing the display unit 118 to display whether the rechargeable battery 130 is being charged or not, the rechargeable battery 130 can be charged directly by the electronic device 10. Thus, a dedicated charger for charging the rechargeable battery 130 is not needed.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A charging circuit for charging a rechargeable battery, the charging circuit comprising:
a voltage conversion unit to convert a voltage of a power supply into an operation voltage, and to output the operation voltage; and
a diode comprising an anode electrically connected to the voltage conversion unit to receive the operation voltage, and a cathode electrically connected to a positive terminal of a rechargeable battery, wherein a negative terminal of the rechargeable battery is grounded;
wherein in response to the voltage conversion unit outputting the operation voltage, the diode is turned on, the operation voltage is reduced by the diode into a charging voltage of the rechargeable battery, and the rechargeable battery is charged by the charging voltage; and
wherein in response to the conversion unit outputting no operation voltage, the diode is turned Off.

2. The charging circuit of claim 1, wherein the voltage conversion unit comprises:
an inductor;
a first capacitor;
a first resistor;
a driver chip comprising a first control pin and a second control pin;
a first electronic switch comprising a first terminal electrically connected to the first control pin of the driver chip through the first resistor, a second terminal electrically connected to the power supply, and a third terminal electrically connected to a ground through the inductor and the first capacitor;
a second electronic switch comprising a first terminal electrically connected to the second control pin of the driver chip, a second terminal electrically connected to the third terminal of the first electronic switch, and a third terminal electrically connected to a ground;
wherein a node between the inductor and the first capacitor functions as an output terminal of the voltage conversion unit, and is electrically connected to the anode of the diode;
wherein the first control pin and the second control of the driver chip alternately outputs high-level signals to turn on the first electronic switch and the second electronic switch;
wherein in response to the first control pin of the driver chip outputting a high-level signal and the second control pin of the driver chip outputting a low-level signal, the first electronic switch is turned on, the second electronic switch is turned off, the inductor and the first capacitor are charged by the power supply through the first electronic switch; and in response to the first control pin of the driver chip outputting a low-level signal and the second control pin of the driver chip outputting a high-level signal, the first electronic switch is turned off, the second electronic switch is turned on, the inductor and the first capacitor are discharged through the second electronic switch; and thus the output terminal of the voltage conversion unit outputs the operation voltage to the diode.

3. The charging circuit of claim 2, wherein the voltage conversion unit further comprises a second capacitor, a second resistor, and a third resistor, the driver chip further comprises a feedback pin electrically connected to the output terminal of the voltage conversion unit through the second resistor, and connected to a ground through the third resistor, and the output terminal of the voltage conversion unit is connected to a ground through the second capacitor.

4. The charging circuit of claim 2, wherein each of the first electronic switch and the second electronic switch is an n-channel metal-oxide semiconductor field-effect transistor (NMOSFET), and the first terminal, the second terminal, and the third terminal of each of the first electronic switch and the second electronic switch are respectively corresponding to a gate, a drain, and a source of the NMOSFET.

5. The charging circuit of claim 1, further comprising a display unit comprising:
a fourth resistor and a fifth resistor;
a light-emitting diode comprising an anode electrically connected to the power supply and a cathode;
a comparator comprising a non-inverting terminal electrically connected to the cathode of the diode, an inverting terminal electrically connected to the positive terminal of the rechargeable battery and electrically connected to the non-inverting terminal of the comparator through the fourth resistor, and an output terminal; and
a third electronic switch comprising a first terminal electrically connected to the output terminal of the comparator through the fifth resistor, a second terminal electrically connected to the cathode of the light-emitting diode, and a third terminal electrically connected to a ground;
wherein in response to the diode being turned on, a voltage of the non-inverting terminal of the comparator is greater than a voltage of the inverting terminal of the comparator, the output terminal of the comparator outputs a high-level signal, the third electronic switch is turned on, the light-emitting diode is lit up to indicate the rechargeable battery is being charged; and
wherein in response to the diode being turned off or the rechargeable battery being fully charged, the voltage of the non-inverting terminal of the comparator is equal to the voltage of the inverting terminal of the comparator, the output terminal of the comparator outputs a low-level signal, the third electronic switch is turned off, and the light-emitting diode is not lit up to indicate the rechargeable battery is not charged.

6. The charging circuit of claim 5, wherein the third electronic switch is an npn-type bipolar junction transistor (BJT), and the first terminal, the second terminal, and the third terminal of the third electronic switch respectively corresponding to a base, a collector, and an emitter of the npn-type BJT.

7. The charging circuit of claim 1, wherein the diode is a Schottky diode.

8. An electronic device comprising:
a shell comprising a recess formed therein to receive a rechargeable battery;
a charging circuit received in the shell and electrically connected to the rechargeable battery to charge the rechargeable battery, the charging circuit comprising:
a voltage conversion unit to convert a voltage of a power supply into an operation voltage, and to output the operation voltage; and
a diode comprising an anode electrically connected to the voltage conversion unit to receive the operation voltage, and a cathode electrically connected to a positive terminal of the rechargeable battery, and a negative terminal of the rechargeable battery electrically connected to a ground;
wherein in response to the voltage conversion unit outputting the operation voltage, the diode is turned on, the operation voltage is reduced by the diode into a charging voltage of the rechargeable battery, and the rechargeable battery is charged by the charging voltage; and
wherein in response to the conversion unit outputting no operation voltage, the diode is turned off to prevent leakage of the rechargeable battery.

9. The electronic device of claim 8, wherein the voltage conversion unit comprises:
an inductor;
a first capacitor;
a first resistor;
a driver chip comprising a first control pin and a second control pin;
a first electronic switch comprising a first terminal electrically connected to the first control pin of the driver chip through the first resistor, a second terminal electrically connected to the power supply, and a third terminal electrically connected to a ground through the inductor and the first capacitor;
a second electronic switch comprising a first terminal electrically connected to the second control pin of the driver chip, a second terminal electrically connected to the third terminal of the first electronic switch, and a third terminal electrically connected to a ground;
wherein a node between the inductor and the first capacitor functions as an output terminal of the voltage conversion unit, and is electrically connected to the anode of the diode;
wherein the first control pin and the second control of the driver chip alternately outputs high-level signals to turn on the first electronic switch and the second electronic switch;
wherein in response to the first control pin of the driver chip outputting a high-level signal and the second control pin of the driver chip outputting a low-level signal, the first electronic switch is turned on, the second electronic switch is turned off, the inductor and the first capacitor are charged by the power supply through the first electronic switch; and in response to the first control pin of the driver chip outputting a low-level signal and the second control pin of the driver chip outputting a high-level signal, the first electronic switch is turned off, the second electronic switch is turned on, the inductor and the first capacitor are discharged through the second electronic switch; and the output terminal of the voltage conversion unit outputs the operation voltage to the diode.

10. The electronic device of claim 9, wherein the voltage conversion unit further comprises a second capacitor, a second resistor, and a third resistor, and the driver chip further comprises a feedback pin electrically connected to the output terminal of the voltage conversion unit through the second resistor, and electrically connected to a ground through the third resistor, the output terminal of the voltage conversion unit is electrically connected to a ground through the second capacitor.

11. The electronic device of claim 9, wherein each of the first electronic switch and the second electronic switch is an n-channel metal-oxide semiconductor field-effect transistor (NMOSFET), and the first terminal, the second terminal, and the third terminal of each of the first electronic switch and the second electronic switch are respectively corresponding to a gate, a drain, and a source of the NMOSFET.

12. The electronic device of claim 8, wherein the charging circuit further comprises a display unit comprising:
a fourth resistor and a fifth resistor;
a light-emitting diode comprising an anode electrically connected to the power supply and a cathode;
a comparator comprising a non-inverting terminal electrically connected to the cathode of the diode, an inverting terminal electrically connected to the positive terminal of the rechargeable battery and electrically connected to the non-inverting terminal of the comparator through the fourth resistor, and an output terminal; and
a third electronic switch comprising a first terminal electrically connected to the output terminal of the comparator through the fifth resistor, a second terminal electrically connected to the cathode of the light-emitting diode, and a third terminal is electrically connected to a ground;
wherein in response to the diode being turned on, a voltage of the non-inverting terminal of the comparator is greater than a voltage of the inverting terminal of the comparator, the output terminal of the comparator outputs a high-level signal, the third electronic switch is turned on, and the light-emitting diode is lit up to indicate the rechargeable battery is being charged; and
wherein in response to the diode being turned off or the rechargeable battery being fully charged, the voltage of the non-inverting terminal of the comparator is equal to the voltage of the inverting terminal of the comparator, the output terminal of the comparator outputs a low-level signal, the third electronic switch is turned off, and the light-emitting diode is not lit up to indicate the rechargeable battery is not charged.

13. The electronic device of claim 12, wherein the third electronic switch is an npn-type bipolar junction transistor (BJT), and the first terminal, the second terminal, and the third terminal of the third electronic switch respectively corresponding to a base, a collector, and an emitter of the npn-type BJT.

14. The electronic device of claim 8, wherein the diode is a Schottky diode.
